(19) United States
(12) Patent Application Publication
(10) Pub. No.: US 2022/0088652 A1
(43) Pub. Date: Mar. 24, 2022

(54) ELECTROKINETIC SOIL DESALINIZATION SYSTEM PROVIDING ENHANCED CHLORIDE REMOVAL AND METHOD

(71) Applicant: TERRAN CORPORATION, Beavercreek, OH (US)

(72) Inventors: Christopher J. ATHMER, Dayton, OH (US); Brent E. HUNTSMAN, Xenia, OH (US)

(21) Appl. No.: 17/480,539

(22) Filed: Sep. 21, 2021

Related U.S. Application Data
(60) Provisional application No. 63/081,052, filed on Sep. 21, 2020.

(51) Int. Cl. B09C 1/08

(52) U.S. Cl. CPC B09C 1/085; B09C 2101/00

(57) ABSTRACT

A system for electrokinetic desalinization and enhanced chloride removal of a portion of soil includes at least one cathode; at least one anode; and a backfill around the cathode of a composition of a granular, conductive material and a backfill around the anode of a second composition comprising the granular, electrically conductive material and a calcium-containing material; an anode discharge line communicating with an interior of the anode; and a cathode discharge line communicating with the interior of the cathode tube. The presence of the calcium-containing material in the granular, electrically conductive material backfilling the anode enhances removal of chloride from the portion of soil.

### RELATED APPLICATIONS

This application claims priority to U.S. Prov. Appln. No. 63,081,052, filed on Sep. 21, 2020, entitled Electrokinetic Soil Desalinization System Providing Enhanced Chloride Removal and Method, the entirety of which is incorporated herein by reference.

### TECHNICAL FIELD

The disclosure relates to systems and methods for desalinization of saline and sodic soils, and more particularly, to systems and methods for desalinization and improved chloride removal of contaminated soil and pore water utilizing electrokinetics.

### BACKGROUND

Soil contaminated by salt poses a significant problem for many facilities. For example, the soil in the vicinity of oil fields and oil pipelines may become so contaminated with salt that the soil is unfit for plant growth. In such situations, groundwater located beneath the surface of the soil and soil pore spaces may become contaminated with salt, and with liquid water containing high concentrations of salt. Therefore, it is necessary to remediate soil containing high concentrations of salt, either as a precipitate or from pore water containing high concentrations of salt. Similarly, the natural soil calcium may be replaced by sodium from brine, causing sodic conditions in the soil, resulting in barren conditions.

One method of soil remediation involves removing soil containing high concentrations of salt and burying the contaminated soil in a pit lined with a water-impermeable liner, such as clay. However, such methods are costly, and require large areas for the pit. This method simply relocates the problem and does not fully address the salt-contaminated soil.

Other methods of soil remediation involve the use of electrokinetics. With electrokinetic soil remediation, the soil remains intact and anode and cathode tubes are installed in patterns in the contaminated soil. An electric current is supplied to the anode and cathode tubes and, through the principles of electroosmosis and electromigration, the disassociated sodium and chloride ions migrate through the pore water in the contaminated soil to collect around the cathode and anode, respectively, where they are extracted. When treating more recent brine spills, both ions are present in high concentrations and can be removed using electrokinetic desalinization. Older brine release sites generally have sodic conditions (elevated sodium to calcium+magnesium balance). Over time, the chloride may have leached from the soil while the sodium has exchanged with some of the natural calcium (or magnesium), causing the soil structure to collapse and become barren. Most electrokinetic processes are unable to satisfactorily remedy such sodic conditions and, specifically, provide enhanced chloride removal.

Accordingly, there is a need for an electrokinetic system and method that can effectively treat sodic soils and enhance chloride removal.

### SUMMARY

In an embodiment, a system for electrokinetic desalinization of soil may include at least one cathode having a hollow cathode tube perforated along its length to allow liquid water to pass through the cathode tube from an exterior thereof to an interior thereof, and a cathode conductor extending along an exterior surface of the cathode tube; at least one anode including a hollow anode tube perforated along its length to allow liquid water to pass through the anode tube from an exterior thereof to an interior thereof, and an anode conductor extending along an exterior surface of the anode tube; a first composition including a granular, electrically conductive material surrounding the at least one cathode along its length, and a second composition including the granular, electrically conductive material and a calcium-containing material surrounding the at least one anode along its length; an optional feed water line communicating with the interior of the anode tube to optimize electrode saturation; an anode discharge line communicating with the interior of the anode tube; and a cathode discharge line communicating with the interior of the cathode tube.

In another embodiment, a method for desalinization of soil may include installing at least one cathode into a portion of soil, the at least one cathode including a hollow cathode tube perforated along its length to allow liquid water to pass through the cathode tube from an exterior thereof to an interior thereof, and a cathode conductor extending along an exterior surface of the cathode tube; installing at least one anode into a portion of soil, the at least one anode including a hollow anode tube perforated along its length to allow liquid water to pass through the anode tube from an exterior surface thereof to an interior thereof, and an anode conductor extending along an exterior surface of the anode tube; backfilling the at least one cathode with a first composition of a granular, conductive material and backfilling the at least one anode with a second composition including the granular, electrically conductive material and a calcium-containing material; providing direct current electricity having a negative polarity connected to the cathode conductor and a positive polarity connected to the anode conductor, the electricity having sufficient power to attract sodium ions in the portion of soil to the at least one cathode and chloride ions in the portion of soil to at least one anode, whereby water in the interior of the cathode tube becomes rich in the sodium ions, and water in the interior of the anode tube becomes rich in the chloride ions; and conveying the water rich in chloride ions from an interior of the anode tube through an anode discharge line communicating with the interior of the anode tube, and conveying the water rich in sodium ions from an interior of the cathode tube through a cathode discharge line communicating with the interior of the cathode tube.

Other objects and advantages of the disclosed electrokinetic soil desalinization system providing enhanced chloride removal and method will be apparent from the following description, the accompanying drawings, and the appended claims.

### BRIEF DESCRIPTION OF THE DRAWINGS

FIG. 1 is a schematic diagram of an embodiment of the disclosed electrokinetic soil desalinization system providing enhanced chloride removal;

FIG. 2 is a detail showing a representative cathode and anode of the system shown in FIG. 1;

FIG. 3 is a schematic diagram of an embodiment of the disclosed electrokinetic soil desalinization system in which the cathodes and anodes are arranged in a repeating hexagonal pattern;

FIG. 4 is a schematic diagram of the system of FIG. 1, showing the electroosmotic migration of ions in contaminated soil;

FIG. 5 is a schematic diagram of an electrokinetic test cell, as described in Example 1;

FIGS. 6A and 6B show soil resistivity by section for the control (FIG. 6A) and with calcium addition at the anode (FIG. 6B);

FIG. 7 shows pH by section for the control and calcium addition tests;

FIGS. 8A and 8B show chloride concentration trends for the control (FIG. 8A) and calcium addition test (FIG. 8B);

FIGS. 9A and 9B show sodium concentration trends for the control (FIG. 9A) and calcium addition test (FIG. 9B); and

FIGS. 10A and 10B show final soil concentrations by section for the control (FIG. 10A) and calcium addition (FIG. 10B).

### DETAILED DESCRIPTION

To rejuvenate sodic soils, the present inventors have discovered that calcium addition at the anode helps in restoring the calcium balance in the soil as well as increasing the overall chloride removal. Specifically, tests on aged sodic soils showed an improvement in the sodium absorption ratio, soil structure, grass growth and stability, and chloride removal as compared to treatment without calcium addition at the anode. Without being held to a single theory, the enhanced chloride removal is due, at least in part, by maintaining a better ionic strength profile between the anodes and cathodes over the duration of treatment. Laboratory experiments and field applications showed that chloride removal without the addition of calcium at the anode is around 70% in low permeable soil. This is attributed to the accumulation of chloride ions in the soil near the anodes. As chloride migrates to the anode against the electroosmotic flow, the soils near the anode became much more conductive than the rest of the soil in the mid and cathode zones. The migration of ions is directly related to the local voltage gradient. The voltage gradient becomes much higher in the relatively ion-free sections and almost zero near the anode. As the voltage gradient nears zero, chloride removal near the anode-most soil sections stops. The results of these studies are presented below in Example 1.

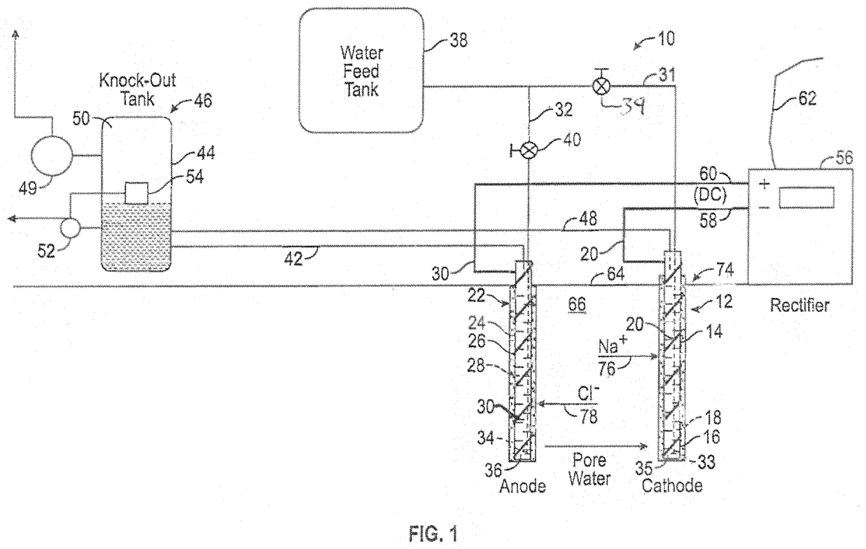

As shown in FIG. 1, in one embodiment, a system for electrokinetic desalinization of a portion of soil, generally designated 10, includes at least one cathode, generally designated 12, having a hollow cathode tube 14 perforated along its length to allow liquid pore water to pass through the cathode tube from an exterior surface 16 thereof to an interior 18 thereof, and a cathode conductor 20 extending along the exterior surface of the cathode tube. The system 10 also includes at least one anode, generally designated 22, having a hollow anode tube 24 perforated along its length to allow liquid pore water to pass through the anode tube from an exterior surface 26 thereof to an interior 28 thereof, and an anode conductor 30 extending along the exterior surface of the anode tube.

Feed water lines 31, 32 communicate with the interiors 18, 28 of the cathode tube 14 and anode tube 24, respectively. Feed water or make-up water lines 31, 32 extend substantially the entire lengths of the cathode tube 14 and anode tube 24, respectively, and open at lower ends 33, 34 thereof in lower portions 35, 36 of the cathode tube 14 and anode tube 24, respectively. In an embodiment, the feed water lines 31, 32 are connected to a source 38 of water, which in an embodiment may take the form of a fresh water feed tank. In embodiments, feed water lines 31, 32 are connected to separate water feed tanks that may make up the source 38 of water, or to a source or sources of water under pressure, such as by a pump or pumps from a well or wells. Flow of feed water through the feed water lines 31, 32 from the water feed tank 38 is regulated by a valves 39, 40, respectively, on the feed water lines.

In an embodiment, the system 10 includes an anode discharge line or siphon tube 42 that communicates with the interior 28 of the anode tube and is connected at an opposite end to a knock-out tank 44 that may be part of a vacuum extraction component, generally designated 46. Similarly, in an embodiment the system 10 includes a cathode discharge line or siphon tube 48 that communicates with the interior 18 of the cathode tube 14 and may be connected to the knock- out tank 44 of the vacuum extraction component 46. In an alternate embodiment of vacuum extraction component 46, knock-out tank 44 may take the form of separate and discrete tanks, with one associated with the cathode discharge line 48 and the other associated with the anode discharge line 42.

The vacuum extraction component 46 optionally includes a vacuum blower 49 for creating a negative pressure in the interior 50 of the knock-out tank 44 in order to draw pore water through the anode discharge line 42 and cathode discharge line 48 into the tank. In an embodiment, the vacuum extraction component 46 includes a brine discharge pump 52 having a float switch 54 within the interior 50 of the knock-out tank 44. In that embodiment, the brine discharge pump 52 is activated by the float switch 54 when the level of pore water from the anode discharge line 42 and cathode discharge line 48 within the tank 44 reaches a predetermined level. Another embodiment of vacuum extraction component 46 may take the form of two discrete systems, each having a knock-out tank 44, vacuum blower 49, and brine discharge pump 52 actuated by float switch 54. In still another embodiment, direct pumping using peristaltic pump(s), e.g., multi-head pumps, is used to draw pore water through the anode discharge line 42 and cathode discharge line 48 into the knock-out tank 44.

In an embodiment, the system 10 includes a source 56 of direct current electricity having a negative terminal 58 connected to the cathode conductor 20 and a positive terminal 60 connected to the anode conductor 30. In an embodiment, the source 56 is a rectifier that receives power over a line 62 from a source (not shown) of electricity, such as a power generator. In alternate embodiments, the source may be one or more of a series of solar panels, wind turbines, and other direct current supply sources.

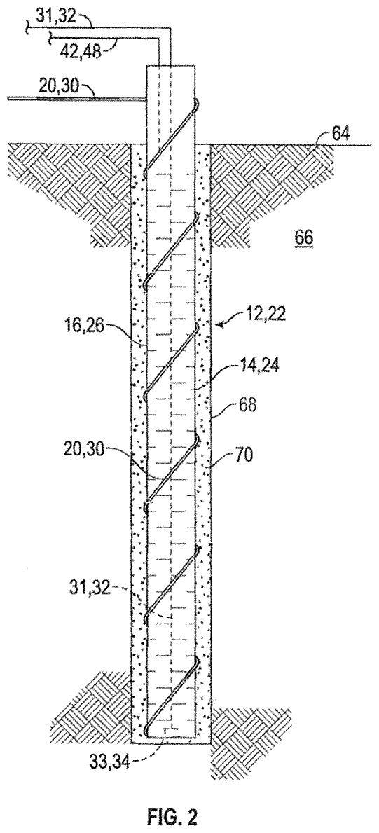

As shown in FIG. 2, in embodiments, the cathode 12 and anode 22 each includes a cathode tube 14 and an anode tube 24, respectively. The cathode tube 14 and/or the anode tube 24 comprise a tube or pipe made of a corrosion-resistant material. In embodiments, the corrosion-resistant material is selected from nylon, hard rubber, and plastic. In one exemplary embodiment, the cathode tube 14 and anode tube 24 are each made of polyvinyl chloride (PVC). In other embodiments, the anode tube 24 is made of PVC or other corrosion-resistant material and the cathode tube 14 is made of a conductive material such as cast iron, ductile iron, or stainless steel.

In embodiments, the cathode tube and anode tube 14, 24 are each 1″-4″ diameter PVC pipe, such as bore-hole screen, having openings therethrough to the interiors 18, 28. In embodiments, the openings are slots approximately 0.010″ wide, or a series of holes approximately 0.010″ in diameter. The cathode tube 14 and anode tube 24 each may be approximately 5′ long, or longer. In embodiments, the cathode tube 14 and anode tube 24 are installed below the surface 64 of a portion of soil 66 that is contaminated within a bore-hole so that the cathode tube and anode tube are oriented substantially vertically and are substantially parallel to each other (see FIG. 1). Each bore-hole may be approximately 2″ to 8″or more in diameter and may be made by direct push or by an auger. In one or more embodiments, each of the bore-holes may be backfilled with a first composition 68 and a second composition 70 comprising a granular, electrically conductive material.

In embodiments, the compositions 68, 70 comprising the granular, electrically conductive material extends throughout each of the backfilled boreholes and therefore surrounds the outer surfaces 16, 26 of the cathode and anode tube 12, 14, respectively. In a particular embodiment, the compositions 68, 70 comprising the granular, electrically conductive material extend along the entire lengths, or substantially along the entire lengths of one or more of, and in embodiments each of the cathode tubes 14 and/or the anode tubes 24. In embodiments, the compositions 68, 70 comprising the granular, electrically conductive material are sized and packed within the bore-holes sufficiently to support the cathode and anode tubes 12, 22 within the bore-holes in a vertical or substantially vertical position, but with enough space to allow liquid pore water to pass therethrough from the contaminated portion of soil 66 to the cathode tube 14 and/or the anode tube 24.

In an embodiment, the granular, electrically conductive material is selected from a conductive carbon and/or a partially graphitized coke. In a more specific embodiment, the granular, electrically conductive material is coke breeze. An example of such a material is Loresco RS-3 Premium Earth Contact Backfill, available from Loresco International, Hattiesburg, Miss. It should be understood that the granular, electrically conductive material used in the first and second compositions to backfill the bore-holes containing the cathode and anode may include the same or different electrically conductive materials.

In a further embodiment, the second composition 70 comprising the granular, electrically conductive material that is used to backfill the borehole of the anode 22 consists of or includes a calcium-containing material. In one embodiment, the calcium-containing material is in the form of garden lime (calcium hydroxide) or crushed limestone. In other embodiments, the calcium-containing material consists of or includes calcium oxide and/or calcium carbonate. In other embodiments, the calcium-containing material is in the form of dolomitic lime and/or hydrated lime.

In one embodiment, the calcium-containing material, which is in powdered and/or granular form, is mixed with the granular, electrically conductive material (i.e., conductive carbon and/or partially graphitized coke and/or coke breeze) at a ratio of about 20:80 to about 80:20 by weight. In one embodiment, the calcium-containing material is mixed with the granular, electrically conductive material at about a 50:50 ratio by volume. In one embodiment, the anode 22 is backfilled with a second composition 70 comprising calcium-containing material and coke breeze at a weight ratio of 60:40. In one embodiment, the granular, electrically conductive material consists of, or consists substantially of, coke breeze and garden lime.

As shown best in FIG. 2, in an embodiment the cathode conductor 20 takes the form of a conductive wire wrapped around and supported on the exterior surface 16 of the cathode tube 14 along its length, and in a particular embodiment, the conductive wire is spiral wrapped about the exterior surface of the cathode tube. Similarly, in an embodiment, the anode conductor 30 is a conductive wire wrapped around the exterior surface 26 of the anode tube 24 along its length, and in a particular embodiment is spiral wrapped around the exterior surface of the anode tube along its length. In an embodiment, the conductive wire comprises the conductors 20, 30 of the cathode 12 and anode 22 includes 3mm diameter LIDA brand anode wire, manufactured by Industrie De Nora of Milan, Italy. Other wire or conductors may be used that may comprise a mixed metal oxide coating. The mixed metal oxide enables the wire or conductor to function as an anode.

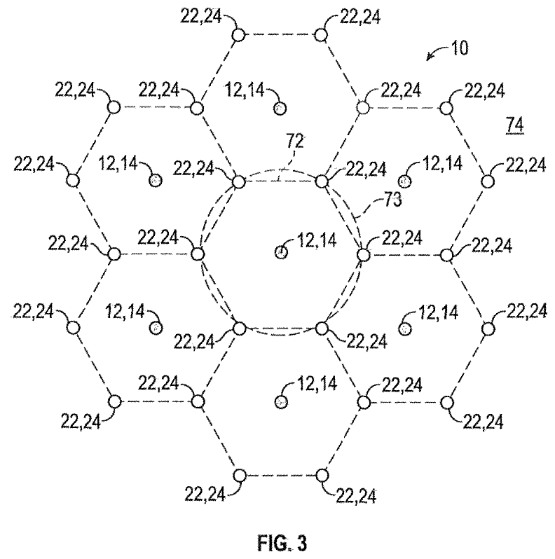

As shown in FIG. 3, in an embodiment, the system 10 includes a plurality of cathodes 12 and anodes 22. Each cathode 12 includes a cathode tube 14 (see FIG. 1), and each anode 22 may include an anode tube 24. The plurality of cathodes 12 and the plurality of anodes 22 are arranged in a pattern wherein at least one cathode of the plurality of cathodes may be surrounded by a plurality of anodes. In a particular embodiment, the plurality of anodes 22 are spaced evenly about at least one cathode 12, and preferably each of the cathodes. In the embodiment shown, each of the anodes 22 may be spaced evenly about a cathode 12, and in a particular embodiment, the spacing of the anode tubes 24 forms a hexagonal grid pattern 72 around each of the cathode tubes 14, in which the grid pattern approximates a cylinder 73 in which a ring of anodes 12 surrounds a center cathode 12. Accordingly, a contaminated soil field, generally designated 74, may be treated by the system 10 by arranging the anodes 22 and cathodes 12 in a geometric pattern, such as a repeating hexagon grid pattern 72.

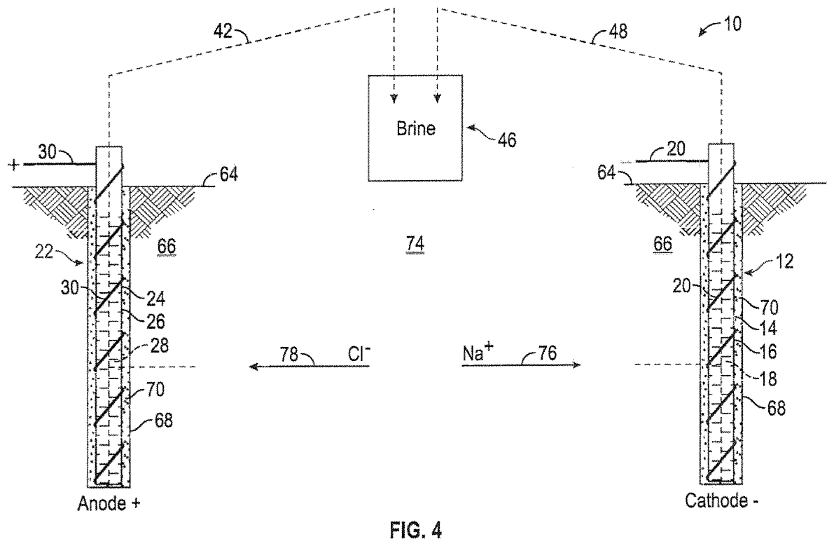

An embodiment of the method of operation of the system 10 is shown schematically in FIG. 4, with reference to FIG. 1. In this embodiment, the method for desalinization of a portion of soil 66 in a contaminated soil field 74 includes installing at least one cathode 12 into the portion of soil 66, the at least one cathode including a hollow cathode tube 14 perforated along its length to allow liquid pore water to pass through the cathode tube from an exterior 16 thereof to an interior 18 thereof, and a cathode conductor 20 extending along the exterior surface of the cathode tube. The cathode tube 14 is installed directly below the surface 64 into the contaminated portion of soil 66 of the field 74. In other embodiments, a bore-hole is first installed substantially vertically in the portion of soil 66 to receive the cathode tube 14. In embodiments, the borehole is oversized and the cathode tube 14 may be fixed in the bore-hole by backfilling with the first composition 68.

In an embodiment, an anode 22 is installed into the portion of soil 66 and includes a hollow anode tube 24 perforated along its length to allow liquid pore water to pass through the anode tube 24 from an exterior surface 26 to an interior 28 thereof, and an anode conductor 30 extending along the exterior surface of the anode tube. The anode tube 24 is installed directly below the surface 64 into the contaminated portion of soil 66 of the field 74. In other embodiments, a bore-hole is first installed vertically or substantially vertically in the portion of soil 66 to receive the anode tube 24. In embodiments, the bore-hole is oversized and the anode tube 24 fixed in the bore-hole by backfilling with the second composition 70 comprising a conductive, granular, electrically conductive material , which includes a calcium-containing material.

Salt contained in the contaminated portion of soil 66 may dissociate into sodium ions and chloride ions when dissolved in pore water. The pore water may be present in the contaminated soil or may be added to the field 74. Direct current electricity having a negative polarity is connected to the cathode conductor 20, and direct current electricity having a positive polarity is connected to the anode conductor 30. The direct current electricity may be supplied by the rectifier 56, or another direct current source. The current at the cathode 12 and anode 22 creates an electric field within the contaminated portion of soil 66 that causes electro-migration of the sodium ions 76 in the pore water contained in the contaminated portion of soil 66 toward the negatively charged cathode conductor 20 and collect in the water within the interior 18 of the cathode tube 14. There, water with a relatively high concentration of sodium atoms may be siphoned to the knock-out tank 44 through siphon tube 48. In an embodiment, the siphon tube 48 is connected to the interior 18 of the cathode tube 14 to draw water from the top or upper portion of the cathode tube 12, and in a particular embodiment, from above the perforations in the cathode tube 14. Fresh make-up water from feed water tank 38 is supplied through line 31 to the lower portion 35 of the cathode tube 14 to replace water containing a high concentration of sodium ions siphoned from the upper portion of the cathode tube in the event the electroosmosis flow, or available groundwater, is insufficient.

Similarly, the electrical field set up between the cathode 12 and anode 22 causes electro- migration of the chloride ions 78 dissolved from the salt in the contaminated portion of soil 66 and present in the pore water within the field 74 toward the positively charged anode conductor 30 to collect in the water contained in the interior 28 of the anode tube 24. The anode line 42 or siphon tube draws pore water containing a high concentration of chloride ions from within the interior 28 of the anode tube 24 and conveys it the knock-out tank 44. In an embodiment, the anode line 42 draws pore water from an upper portion of the anode tube 24, and in a particular embodiment, from a location above the perforations in the tube. Fresh make-up water from feed water tank 38 is supplied through line 32 to the lower portion 36 of the anode tube 24 to replace water containing a high concentration of chloride ions siphoned from the upper portion of the anode tube.

The mixture of pore water from the cathode 12 containing a high concentration of sodium ions and the pore water from anode 22 containing a high concentration of chloride ions mix in the knock-out tank 44 to reform brine for disposal.

Rate of migration of the sodium ions 76 and chloride ions 78 may be proportional to the voltage gradient between the cathode 12 and the anode 22, ionic mobility, and convectional flow (hydraulic plus electroosmotic) of ions through the contaminated portion of soil 66 in the field 74.

The system 10 and method thus provide an efficient and economical means for remediating soil that may be contaminated with salt and may be used to remediate soil that has been contaminated with other contaminants that disassociate into positive and negative ions when dissolved in water. The system 10 and method obviate the need for remediating contaminated soil by removing the soil and placing it in a pit or other landfill, thereby saving money. As an added step, in an embodiment the rectifier 56 (FIG. 1) is actuated to reverse polarity to balance the pH gradient within the portion of soil 66 at the end of the process described with reference to FIG. 4.

### EXAMPLE 1

Equipment and Soil Used

Two tests were performed that compare the use of electrokinetic (EK) treatment with calcium addition at the anode and EK treatment alone, without calcium addition. These EK tests were carried out in benchtop cells made from 4-inch diameter acrylic tubes. The tubes measure 10.1 mm in diameter and 30 cm long. The end caps support the cells and have a milled groove to seal the cell edges. The cells have drilled and tapped access holes for plastic plugs or fittings evenly spaced across the tube. The end compartments for the anode and cathode have openings for fluid management and electrode connections. Power is provided by a benchtop DC power supply (HP E3612A) set to a fixed voltage between 0.4 and 0.5 volts per centimeter.

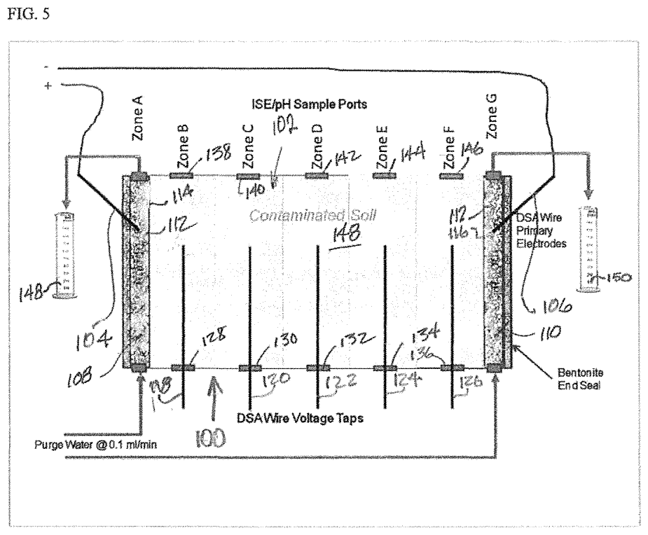

The test cell, generally designated 100, is shown in FIG. 5. The anode zone is labeled Zone A while the center section 102 containing the contaminated portion of soil has 5 evenly spaced ports labeled Zones B, C, D, E, & F. The cathode zone is labeled Zone G. The distance between anode electrode 104 and cathode electrode 106 is 20 cm, resulting in each of the 5 sections between them (B-F) measuring 4 cm in length. The anode and cathode sections 108, 110, respectively, are filled with a granular material 112 consisting of coke breeze (Loresco SWS) to evenly distribute the electric field across the anode and cathode electrode faces 114, 116, respectively, and to allow fluids to be exchanged. The primary anode and cathode electrodes 104, 106, respectively, are made of 3mm dimensionally stable anode (DSA) wire inserted within the granular material 112. For one of the tests, the granular material 112 used to fill the anode section 108 further included garden lime (calcium hydroxide, pH 10), which was mixed with the coke breeze at a 60:40 ratio by weight (calcium hydroxide to coke breeze).

DSA wire probes 118, 120, 122, 124, 126 were inserted through sealed fittings 128, 130, 132, 134, 136 in the bottom ports of each soil section B-F to measure the voltage field across the cell 102. The top ports 138, 140, 142, 144, 146 at each section allow for the direct measurement of pH, chloride and sodium via ion-specific electrodes (ISE) (not shown). The direct sodium and chloride measurements were qualitative indicators used for relative concentration measurements. High or low pH can impose interference in ISE readings. Even with the imposed errors and interferences, direct ISE measurements provide a good non-destructive relative trend analysis of ion movement during the tests.

The tests were made using a brine-impacted portion of soil 148 from nearby a North Dakota oil well. The portion of soil 148 is very high in clay and silt with little or no sand. Soil from that area is naturally high in sulfate and chloride relative to most other natural soils. A 5-gallon bucket portion of soil 148 was dried, crushed, and homogenized. When packing the test cell center section 102, every attempt was made to mimic field conditions. For this experiment, the portion of soil 148 was hydrated to about 25% in a kitchen mixer using unsoftened tap water. This made a highly cohesive portion of soil 148 similar to actual field conditions. The portion of soil 148 was hand packed into the center section 102 of the test cell 100 in 1 cm layers. Each soil layer was then piston packed with about 100 lbs pressure (˜8 psi).

Experiments Conducted

Before starting each test, untreated soil samples were extracted with deionized water and analyzed for pH, chloride, and sodium using ISE probes in the lab. Direct soil measurements were also performed from ports B-F in the packed cell 100 establishing initial conditions. Each ISE probe was reference calibrated in a 1000 ppm standard (chloride and sodium) or pH 7 standard before and after direct soil readings.

At the conclusion of each test, the treated center section 102 of the soil test cell 100 was sectioned, centered by port location B-F. Each whole section B-F was extracted with deionized water and analyzed using ISE/pH probes. The collected anode and cathode fluid 148, 150 was similarly analyzed. For the whole section extraction analysis, the ISE probes were calibrated using 3 standards (100 ppm, 1000 ppm, and 10,000 ppm) for better accuracy. Note that during operations, some of the chloride was oxidized to chlorine and not accounted for in material balance calculations.

The tests were conducted under constant voltage of 0.5 V/cm. The starting current generally started out above 200 mA and would drop over the course of the test to around 25 mA, an indication desalinization was occurring. Unsoftened tap water was supplied to the anode and cathode sections 108, 110, respectively to slowly purge each compartment at a rate of 0.1 ml/min.

During the experiments, outflow of anode fluid 148 and cathode fluid 150 at the anode section 108 and cathode section 110 was collected individually in graduated 1-liter polyethylene bottles. Data collected during each test run included voltage, current, incremental voltage at each port A to F relative to G (cathode) for gradient determination, fluid volume collected at anode section 108 and cathode section 110 as well as the pH, relative chloride and sodium at each section.

Results

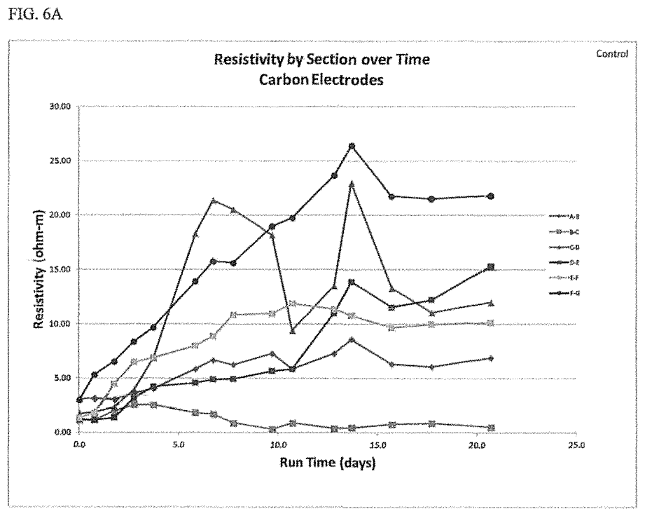

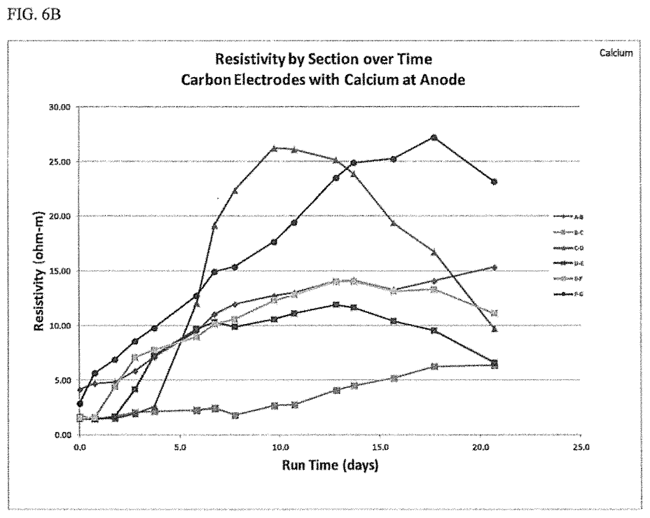

The results of the control test with no calcium addition to the granular material 112 at the anode section 108 showed, as in previous experiments, that there was buildup of chloride in the portion of soil 148 near the anode section 108 with an overall chloride removal of 66%. The electrical resistivity profile during the control test, shown in FIG. 6A, clearly indicates the loss of voltage gradient near the anode section 108. In interval B-C, the resistivity decreased slightly over time while the other zones increased significantly. This is reflective of the chloride ions accumulated in sections B and C and deionization in the other zones. The calcium test resistivity increased (FIG. 6B) in all sections of the center section 102 of the cell 100, indicating a high degree of salt removal, even in cell intervals A-B and B-C.

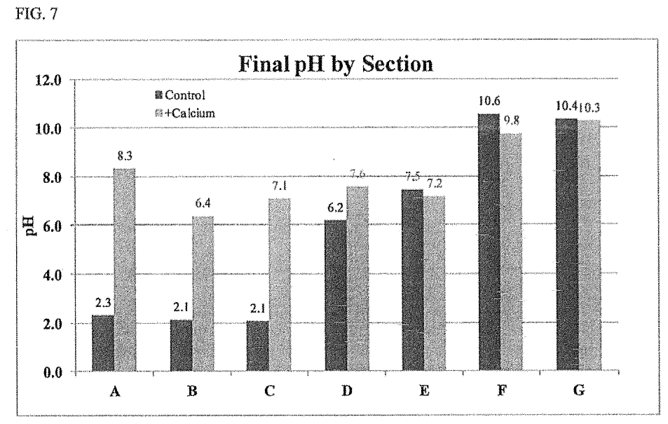

Another result of calcium addition is the relatively gradual pH profile change across the test cell center section 102 as compared to the control test. At the conclusion of the control test, a soil pH profile across the center section 102 from anode section 108 to cathode section 110 of 2, 7 and greater than 10 (FIG. 7). The calcium test had a pH profile of 8, 7 and 10 as shown in FIG. 7. This indicates the calcium neutralizes the normally acidic anode zone soils.

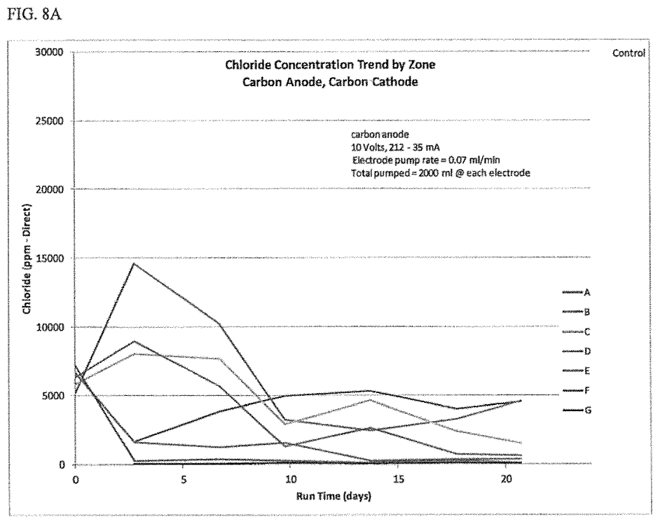

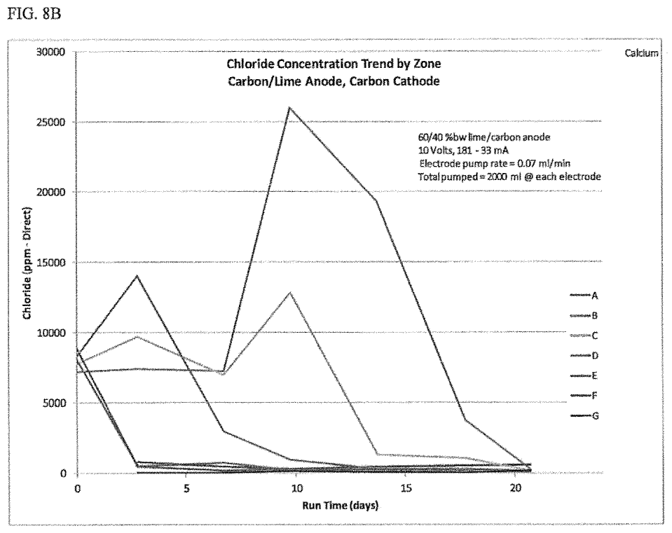

FIG. 8A shows the chloride direct ISE-based concentrations for the control test. The accumulation of chloride near the anode section 108 resulted in very conductive soil and practically extended the anode section 108 into the soil zones B and C. The ISE reading for section B was similar to the anode section 108 and section C was about a third of A and B, while the other sections were basically devoid of chloride. For the test with calcium added to the anode section 108 (FIG. 8B), the final chloride concentration profile indicated more effective chloride removal when compared to the control test. Section B of the test cell 100 was the last to clean up but did so remarkably well after spiking to almost 4 times the initial chloride concentration. All test cell sections B-F had been removed of excess chloride by day 20 of constant voltage operation.

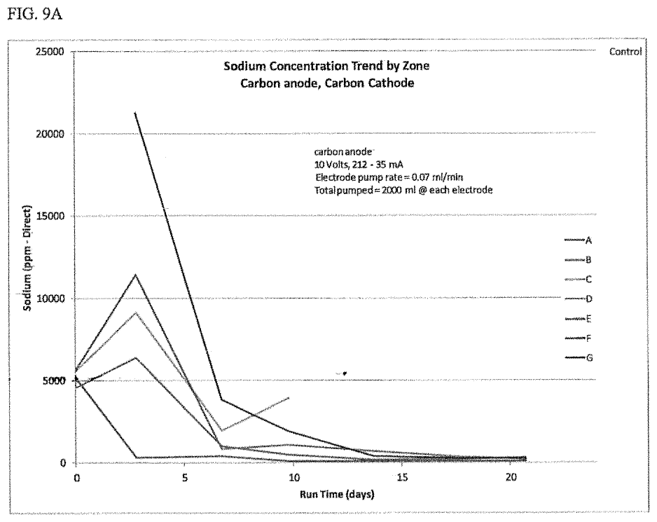

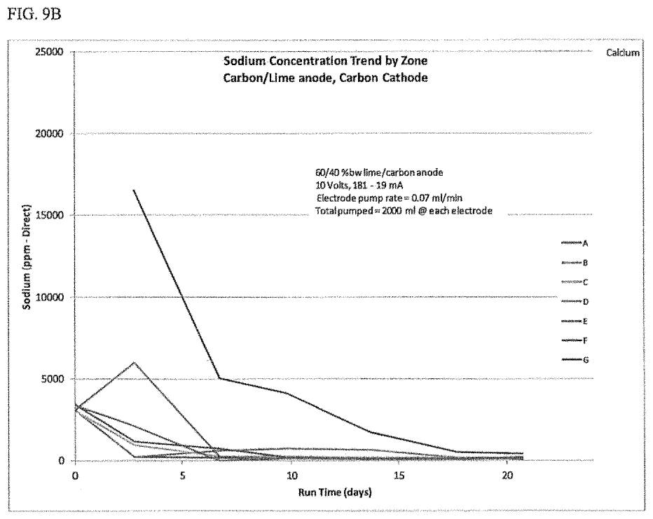

The sodium direct ISE concentrations are shown in FIGS. 9A and 9B. By day 13, the sodium concentration reduced significantly, including the cathode fluid 150 in Zone G (cathode section 110) in the control test (FIG. 9A). Sodium ISE measurements in sections A, B, and C were erroneous due to the very low pH and prevalence of interfering H+ ions and were removed from the data set. FIG. 9B shows the sodium concentration trend by section for the calcium addition test. Results were similar to the control with a slight lag time in removal. This might have been due to a positive bias in the ISE measurements caused by elevated calcium ions. The calcium test required approximately 18 days to remove the excess sodium from the soil 148, compared to about 13 days for the control test.

Chloride and sodium results for the control test agree with previous tests on brine impacted soils. The sodium was removed quite effectively while the chloride was removed from the cathode section 110 most and center zones C, D, and E, but less effectively in the area of the anode section 108. There was a clear abundance of chloride ions near the anode section 108 along with very low pH and high electrical conductivity. This leads to the conclusion that hydrochloric acid buildup in this area reduces the voltage drop near the anode section 108. This limits the electromigration of the chloride to the anode section 108. However, calcium addition at the anode section 108 dramatically improved the chloride removal throughout the test cell 100.

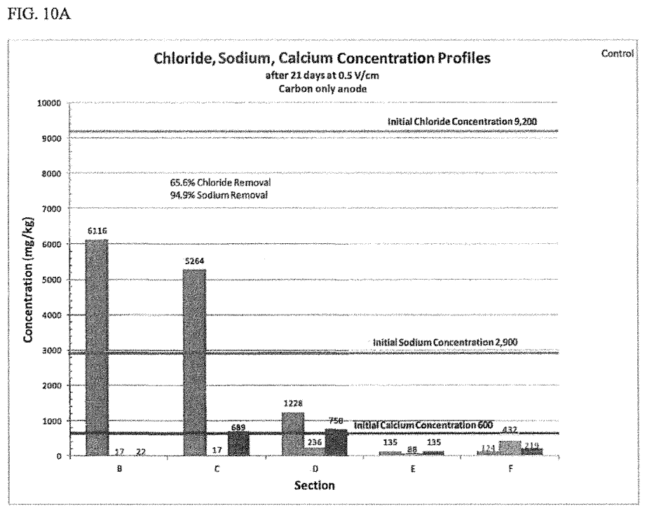

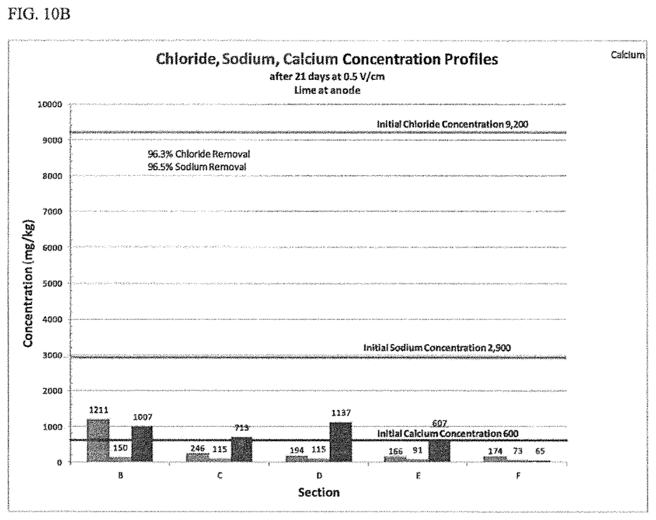

At the completion of the tests, each entire section of soil 148 from the test cell 100 was extracted and analyzed for sodium, chloride, and calcium. Results correlated well with the final in-situ ISE measurements. Soil concentration results by section for the control test are presented in FIG. 10A. This graph confirms the chloride is almost completely removed from sections D, E, and F, while substantial amounts remained in sections B and C. Overall, approximately 66% of the chloride was removed together with 95% of the free sodium. Soluble calcium was removed or precipitated to some degree dropping from an average of 600 ppm to 150 ppm. Also noted was the final direct chloride ISE concentrations trended directly with the final extraction-based soil concentrations; where B and C are high, section D was moderately low, and E and F showed very little chloride.

The final soil extraction analysis for the calcium addition test, FIG. 10B, shows a different profile for chloride, sodium and calcium. The chloride concentrations were low across the cell 100, even sections B and C with an overall removal of 95%. The final sodium soil concentrations were similar to the control. The calcium soil concentrations were slightly higher than the initial concentration with the average concentration rising from 600 to 760 ppm.

Conclusions

The addition of a calcium-containing material at the anode during electrokinetic treatment of brine soils increased chloride removal by 30%. This is a surprising and potentially huge benefit to future desalinization projects. In addition, this treatment adds much needed calcium to the soil structure which will increase the future productivity of the soil. Calcium addition at the anode should be used for any soil desalination project using electrokinetics.

While the methods and forms of apparatus herein described constitute preferred embodiments of the disclosed electrokinetic soil desalinization system and method, it is to be understood that variations may be made to these methods and systems without departing from the scope of the invention.

What is claimed is:

1. A system for electrokinetic desalinization of a portion of soil, the system comprising:
at least one cathode including a hollow cathode tube perforated along its length to allow liquid water to pass through the cathode tube from an exterior thereof to an interior thereof, and a cathode conductor extending along an exterior surface of the cathode tube;
at least one anode including a hollow anode tube perforated along its length to allow liquid water to pass through the anode tube from an exterior thereof to an interior thereof, and an anode conductor extending along an exterior surface of the anode tube;
a first composition comprising a granular, electrically conductive material surrounding the at least one cathode along its length, and a second composition comprising the granular, electrically conductive material further comprising a calcium material and surrounding the at least one anode along its length;
an optional feed water line communicating with at least the interior of the anode tube;
an anode discharge line communicating with the interior of the anode tube; and
a cathode discharge line communicating with the interior of the cathode tube.

2. The system of claim 1, wherein the cathode tube and the anode tube are each oriented substantially vertically.

3. The system of claim 1, further comprising a source of direct current electricity having a negative terminal configured to be connected to the cathode conductor and a positive terminal configured to be connected to the anode conductor.

4. The system of claim 1, further comprising a source of water connected to the feed water line.

5. The system of claim 4, wherein the feed water line communicates with the anode tube to insert the water from the source of water into a lower portion of the anode tube.

6. The system of claim 5, wherein the feed water line extends along the interior of the anode tube and is open at the lower portion of the anode tube.

7. The system of claim 1, further comprising a vacuum extraction component connected to the anode discharge line and to the cathode discharge line.

8. The system of claim 7, wherein the vacuum extraction component includes a knock-out tank, connected to the cathode discharge line and to the anode discharge line, for collecting water from the interior of the cathode tube and the interior of the anode tube.

9. The system of claim 8, wherein the vacuum extraction component includes a vacuum blower connected to the knock-out tank to maintain a pressure within the knock-out tank below atmospheric pressure.

10. The system of claim 9, wherein the vacuum extraction component includes a brine discharge pump connected to the knock-out tank for pumping brine from the interior of the knock-out tank above a predetermined volume.

11. The system of claim 1, wherein the granular, electrically conductive material is selected from a conductive carbon, a partially graphitized coke, coke breeze, or mixtures thereof.

12. The system of claim 1, wherein the calcium-containing material is selected from calcium hydroxide, crushed limestone, calcium oxide, calcium carbonate, dolomitic lime, and/or hydrated lime, or mixtures thereof.

13. The system of claim 1, wherein the calcium-containing material is mixed with the granular, electrically conductive material at a weight ratio of from about 20:80 to about 80:20.

14. The system of claim 1, wherein the cathode tube is made of a material selected from polyvinyl chloride, cast iron, and stainless steel.

15. The system of claim 14, wherein the anode tube is made of polyvinyl chloride.

16. The system of claim 1, wherein the anode tube is made of a corrosion-resistant material.

17. The system of claim 1, wherein the cathode conductor is a conductive wire wrapped about the exterior surface of the cathode tube along its length and the anode conductor is a conductive wire wrapped about the exterior surface of the anode tube along its length.

18. The system of claim 1, wherein the at least one cathode includes a plurality of cathode tubes and the at least one anode includes a plurality of anode tubes; the plurality of cathode tubes and plurality of anode tubes arranged in a pattern wherein at least one cathode tube of the plurality of cathode tubes is surrounded by the plurality of anode tubes.

19. A method for desalinization and enhanced removal of chloride from a portion of soil, the method comprising:
installing at least one cathode into a portion of soil, the at least one cathode including a hollow cathode tube perforated along its length to allow liquid water to pass through the hollow cathode tube from an exterior thereof to an interior thereof, and a cathode conductor extending along an exterior surface of the hollow cathode tube;
installing at least one anode into the portion of soil, the at least one anode including a hollow anode tube perforated along its length to allow liquid water to pass through the hollow anode tube from an exterior thereof to an interior thereof, and an anode conductor extending along an exterior surface of the hollow anode tube;
backfilling the at least one cathode with a first composition of a granular, conductive material and backfilling the at least one anode with a second composition comprising the granular, electrically conductive material and a calcium-containing material;
providing direct current electricity having a negative polarity connected to the cathode conductor and a positive polarity connected to the anode conductor, the electricity having sufficient power to attract sodium ions in the portion of soil to the at least one cathode and chloride ions in the portion of soil to the at least one anode, whereby water in the interior of the hollow cathode tube becomes rich in the sodium ions, and water in the interior of the hollow anode tube becomes rich in the chloride ions; and
conveying water with a high concentration of chloride ions from an interior of the hollow anode tube through an anode discharge line communicating with the interior of the hollow anode tube and conveying water with a high concentration of sodium ions from an interior of the hollow cathode tube through a cathode discharge line communicating with the interior of the hollow cathode tube.

20. The method of claim 19, further comprising providing make-up water to one or both of the interior of the hollow anode tube and the interior of the hollow cathode tube.
